(19) United States
(12) Patent Application Publication
(10) Pub. No.: US 2022/0387841 A1
(43) Pub. Date: Dec. 8, 2022

(54) SYSTEMS FOR MECHANICALLY ASSISTING REHABILITATION OF A PATIENT

(71) Applicant: Tech Gym Pty Ltd, New South Wales (AU)

(72) Inventors: Dang LÊ MINH, New South Wales (AU); Rowan JEFFREY SMITH, New South Wales (AU)

(73) Assignee: Tech Gym Pty Ltd, New South Wales (AU)

(21) Appl. No.: 17/755,054

(22) PCT Filed: Oct. 20, 2020
(86) PCT No.: PCT/AU2020/051129

§ 371 Date: Apr. 20, 2022

(30) Foreign Application Priority Data
Oct. 21, 2019 (AU) 2019903951

(51) Int. Cl. A63B 21/00; A63B 24/00; A63B 71/06; A63F 13/218

(52) U.S. Cl. CPC A63B 21/00181; A63B 24/0087; A63B 71/0622; A63B 21/4033; A63F 13/218; A63B 2220/51; A63B 2220/833; A63B 2024/0096; A63B 2225/02; A63B 2220/54; A63B 2024/0093

(57) ABSTRACT

System for mechanically assisting rehabilitation of a patient. The system includes: a manipulator having at least five degrees of freedom and defining a free end; a limb support for supporting a limb of the patient, and secured relative to the free end of the manipulator; a force sensor operatively connected to the limb support to allow measuring input forces applied by the patient; and a processor communicatively connected to the force sensor, the manipulator, and a memory store which defines a scale factor. The processor is configured to control operation of the manipulator to move the limb support, and further configured so that responsive to receiving an input force measurement from the force sensor, the processor determines an applied force as a function of the input force and the scale factor.

### TECHNICAL FIELD

The present disclosure relates, generally, to systems for enhancing movement of users and, in particular, to systems for mechanically assisting rehabilitation of a patient.

### BACKGROUND

Patients who have suffered an injury to a limb or joint, such as due to trauma, or are experiencing difficulty controlling movement of a limb, such as due to suffering a stroke, are often treated with physical therapy (also referred to as physiotherapy) to restore range of movement. Rehabilitation of such injuries usually involves the patient repeatedly performing one or more specific physical exercises, typically being a cycle of movements selected to strengthen a limb or otherwise enhance limb control.

Clinicians, such as physiotherapists, are trained to assess a patient's condition, select appropriate exercises to treat the condition, instruct the patient to perform the exercises, and supervise effective performance of the exercises. Supervision often requires the clinician to physically support the patient to guide movement of limbs. This leads to clinicians experiencing injuries due to excessive loading and/or performing repetitive movements, which can result in a clinician being unable to work, consequently increasing burden on a health services provider and reducing standard of care for patients.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

According to at least one disclosed embodiment there is provided a system for mechanically assisting rehabilitation of a patient. The system includes: a manipulator having at least five degrees of freedom and defining a free end; a limb support for supporting a limb of the patient, the limb support secured relative to the free end of the manipulator; a force sensor operatively connected to the limb support to allow measuring input forces applied to the limb support by the patient moving its limb; and a processor communicatively connected to the force sensor, the manipulator, and a memory store defining a scale factor. The processor is configured to control operation of the manipulator to move the limb support, so that responsive to receiving an input force measurement from the force sensor, the processor determines an applied force as a function of the input force and the scale factor, and operates the manipulator to apply the applied force to the limb support to cause the limb support to move.

The scale factor may be defined as a percentage of input force. Alternatively or additionally, the memory store may define a calibration process including a sequence of defined forces, and, responsive to receiving force measurements corresponding with the sequence, the processor is configured to define the scale force.

The force sensor may be configured to measure input force at a defined frequency of greater than 10 Hz, and the processor be configured to determine and apply the applied force responsive to receiving each input force measurement, thereby applying the applied force at the same frequency, i.e. greater than 10 Hz. The defined frequency may be equal to, or greater than, 100 Hz.

The processor may be configured to determine a position of the limb support relative to a reference position, and the memory store define a pair of movement thresholds relating to an exercise. In such embodiments, the processor may be further configured so that responsive to determining that the limb support is moved in a cycle between the movement thresholds, the processor logs an exercise repetition in the memory store.

The processor may be configured to populate a database with the scale factor, input force measurements and exercise repetitions logged in a rehabilitation session. Alternatively or additionally, the processor may be configured to populate a report with patient identification information, the scale factor and exercise repetitions logged in a rehabilitation session. The processor may be further configured to populate the report with other information obtained during a rehabilitation sessions, such as repetitions attempted, repetitions successfully completed, rate of successful repetitions (e.g. per minute), and applied force and/or torque applied by the manipulator.

The processor may be configured to determine a position of the limb support relative to a target position, and, responsive to the processor determining the limb support is within a defined range of the target position for a defined period, the processor is configured to determine an assist force and operates the manipulator to apply the assist force, in addition to the applied force, to cause the limb support to move to the target position. In such embodiments, the processor may be configured to increase the assist force proportionally to decreasing a distance between the limb support and the target position. Furthermore, the processor may determine the assist force to comprise at least one of linear force and torque.

The memory store may define a virtual force field defining one or more boundaries in at least two dimensions, and the processor be configured to determine a position of the limb support relative to the one or more boundaries, wherein responsive to the processor determining the limb support is within a threshold range of any boundary of the virtual force field, the processor determines a resistance force to counteract the input force acting towards the boundary, and operates the manipulator to apply the resistance force to inhibit the limb support from moving outside of the virtual force field. In such embodiments, the processor may be configured to determine the resistance force to comprise at least one of linear force and torque.

The processor may be communicatively connected to a screen and configured to operate the screen to display graphics relating to exercises.

The processor may be configured to execute a video game application relating to the exercises, and the graphics, displayed by the screen, illustrate elements of the video game.

The processor may be configured so that responsive to receiving an input force measurement from the sensor, the processor effects control of one or more of the elements of the video game, and operates the screen to display the control of the one or more elements.

The system may include a touch screen operable to display the graphics and receive user input.

The system may include a base connected to the manipulator and configured to support the manipulator relative to a surface. The base may include an elevation mechanism operable to lift the manipulator away from the surface.

The limb support may include a patient input mechanism communicatively connected to the processor, and the processor may be configured so that responsive to operation of the patient input mechanism, the processor causes one of initiating and ceasing movement of the manipulator.

The system may include a quick-release mechanism arranged to releasably connect the limb support to the free end of the manipulator, so that operating the quick-release mechanism allows the limb support to be disengaged from the manipulator.

The limb support may be shaped to receive a portion of the limb of the patient.

The limb support may include at least one restraint member configured to allow releasably securing the limb support to the limb of the patient.

The force sensor may be configured as a force-torque sensor arranged to measure linear force and torque applied to the limb support by the patient.

According to at least one disclosed embodiment there is provided a method for mechanically assisting rehabilitation of a patient, the method including: defining a scale factor; releasably securing a limb of the patient against a limb support secured relative to an end effector of a manipulator; exerting force, by the limb of the patient, causing the limb support to transmit an input force to a force sensor operatively connected to the limb support; receiving the input force, by a processor, and determining an applied force as function of the scale factor and the input force; and operating the manipulator, by the processor, to apply the applied force to the limb support, causing the limb support to move the patient's limb.

According to at least one other disclosed embodiment, there is provided a system for mechanically assisting rehabilitation of a patient, the system including: a manipulator having at least five degrees of freedom and defining a free end; a limb support for supporting a limb of the patient, the limb support secured relative to the free end of the manipulator; a force sensor operatively connected to the limb support to allow measuring input forces applied to the limb support by the patient; and a processor communicatively connected to the force sensor, the manipulator, and a memory store storing a virtual force field defining one or more boundaries in at least two dimensions, the processor configured to control operation of the manipulator to move the limb support, and configured to determine a position of the limb support relative to the boundaries, wherein responsive to the processor determining the limb support is within a threshold range of any boundary of the virtual force field, the processor determines a resistance force to counteract the input force acting towards the boundary, and operates the manipulator to apply the resistance force to inhibit the limb support from moving outside of the virtual force field.

According to at least one other disclosed embodiment, there is provided system for mechanically assisting rehabilitation of a patient, the system including: a manipulator having at least five degrees of freedom and defining a free end; a limb support for supporting a limb of the patient, the limb support secured relative to the free end of the manipulator; a processor communicatively connected to the manipulator and a memory store defining a target position, the processor configured to control operation of the manipulator to move the limb support, and configured to determine a position of the limb support relative to the target position, wherein responsive to the processor determining the limb support is within a defined range of the target position for a defined period, the processor determines an assist force and operates the manipulator to apply the assist force to cause the limb support to move to the target position.

In such embodiments, the processor may be configured to increase the assist force proportionally to decreasing a distance between the limb support and the target position.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated embodiments may comprise steps, features and/or integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompany drawings in which:

FIG. 1 is a perspective view of a treatment apparatus which is part of a system for mechanically assisting rehabilitation of a patient. The apparatus is shown in a ‘sitting mode’ configuration;

FIG. 2 is a perspective view of the treatment apparatus shown in FIG. 1 in a ‘standing mode’ configuration;

FIG. 3 is a perspective view of a limb support which is part of the treatment apparatus shown in FIGS. 1 and 2;

FIG. 4 is a diagram illustrating architecture of the system shown in FIGS. 1 and 2;

FIG. 5 is a three-dimensional diagram illustrating a virtual force field defined relative to the treatment apparatus shown in FIGS. 1 and 2; and

FIGS. 6 and 7 are side view diagrams illustrating a target position and associated range defined relative to the treatment apparatus shown in FIGS. 1 and 2.

### DESCRIPTION OF EMBODIMENTS

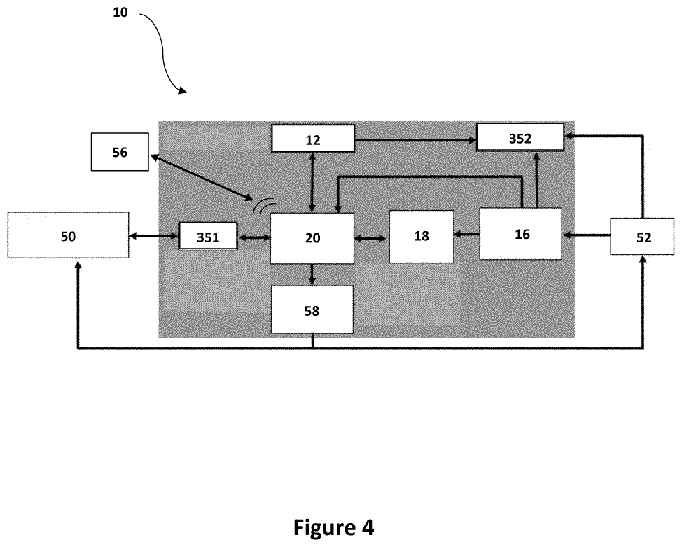

In the drawings, reference numeral 10 generally designates a system 10 for mechanically assisting rehabilitation of a patient 52 (FIG. 4). The system 10 includes: a manipulator 12 having at least five degrees of freedom and defining a free end 14; a limb support 16 for supporting a limb of the patient 52, the limb support 16 secured relative to the free end 14 of the manipulator 12; a force sensor 18 operatively connected to the limb support 16 to allow measuring input forces applied to the limb support 16 by the patient 52 moving its limb; and a processor 20 communicatively connected to the force sensor 18, the manipulator 12, and a memory store 56 (FIG. 4) which defines a scale factor. The processor 20 is configured to control operation of the manipulator 12 to move the limb support 16, and further configured so that responsive to receiving an input force measurement from the force sensor 18, the processor 20 determines an applied force as a function of the input force and the scale factor, and operates the manipulator 12 to apply the applied force to the limb support 16 to cause the limb support 16 to move.

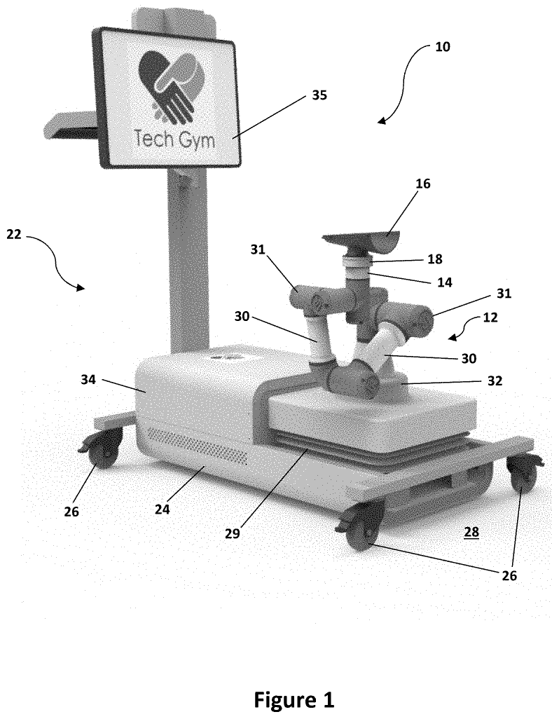

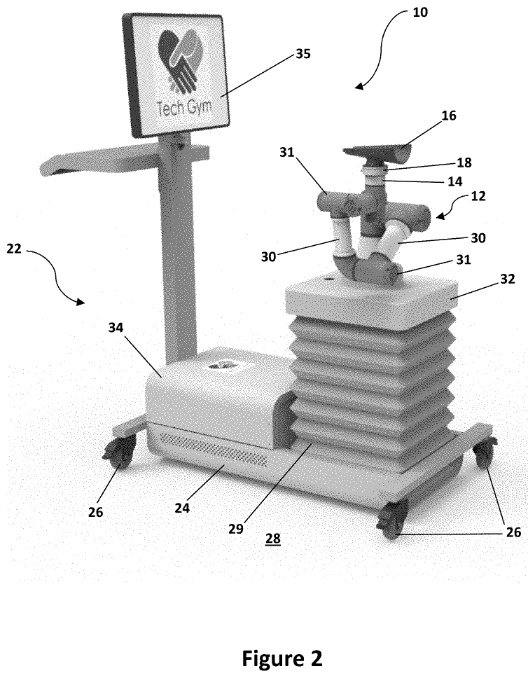

FIGS. 1 and 2 illustrate a treatment apparatus 22 which is a component of the system 10. FIG. 1 shows the apparatus 22 in a ‘sitting mode’ configured to treat seated patients. FIG. 2 shows the apparatus 22 in a ‘standing mode’ configured to treat standing patients. The apparatus 22 is configured to be light-weight, typically having a mass of less than 50 kg, and dimensioned to allow passage through internal doorways, typically being less than 800 mm wide.

The treatment apparatus 22 includes a base 24 mounted on a plurality of castor wheels 26 arranged to support the base 24 operatively above a surface 28, such as a floor or table, and allow moving the apparatus 22 across the surface 28. The manipulator 12, in the form of a robotic arm, is secured relative to the base 24. In the illustrated embodiment, the base 24 includes an elevation mechanism (not shown) housed within an extendible shroud 29 and operable to lift the manipulator 12 away from the surface 28. The elevation mechanism is typically configured as a scissor-lift type mechanism (not shown) drivingly engaged with an electric motor (not shown).

The manipulator 12 includes a plurality of sections 30 and joints 31, each section 30 being rotatably connected to at least one other section 30 by a joint 31 such that the manipulator 12 has at least five degrees of freedom. The illustrated embodiment has sections 30 connected about six axes to define six degrees of freedom. At least one sensor, such as a rotary encoder (not illustrated), and at least one actuator (not illustrated) is operatively connected to each joint 31. Operation of the sensors allows the processor 20 to determine a position and orientation of each section 30 and joint 31, including the free end 14 and the limb support 16, relative to a reference point. Operation of the actuators allows rotating one or more of the joints 31 about an axis, typically being rotatable by 360 degrees. The manipulator 12 is typically configured as a collaborative “cobot” robotic arm having a compact footprint, low weight of approximately 11 kg and pay load equal to or greater than 3 kg. It will be appreciated that, in other embodiments (not shown), the manipulator 12 may be alternatively configured and operable to provide the at least five degrees of freedom.

The manipulator 12 has a fixed end 32 secured to the base 24 and the free end 14, also referred to as an end effector 14, arranged distally from the base 24. The manipulator 12 is operable to move the free end 12 freely in all three dimensions, within the constraints of physical motion capable by the manipulator 12.

The limb support 16 is secured relative to the free end 14 of the manipulator 12. In the illustrated embodiment, the force sensor 18 is interposed between the limb support 16 and the free end 14 so that the limb support 16, sensor 18 and the free end 14 are fixed together. This allows force exerted on the limb support 16 to be directly transferred to the force sensor 18. In other embodiments (not shown), the sensor 18 is arranged in an alternative position, such as within one of the sections 30, to be operatively connected to the limb support 16.

The force sensor 18 is typically configured as a force-torque sensor to allow measuring linear force and rotational force (torque) applied to the limb support 16. The force-torque sensor is configured to detect force exerted on the limb support 16 in any linear direction by measuring directional components according to an x, y and z axis system, and in any rotational direction by measuring rotation components according to a roll, pitch and yaw axis system. It will be appreciated that alternative mechanisms or systems may be suitable for sensing linear and rotational forces exerted on the limb support 16, such as calculating the forces from a kinematic model.

A housing 34 is mounted to the base 24. The housing 34 defines an internal volume within which the processor 20 is arranged. The processor 20 is communicatively connected to the sensor 18, the manipulator 12 and the memory store 56 (FIG. 4). In the illustrated embodiment, the memory store 56 is remotely hosted, typically on a server (not illustrated), and the housing 34 contains a communications module (not illustrated) operable to allow the processor 20 to communicate with the memory store 56, such as via the Internet. The communications module is further configurable to facilitate communication with an intranet to allow the system 10 to integrate with a clinical data network, such as a hospital or local health district intranet. In other embodiments (not illustrated), the memory store 56 is a component of the apparatus 22 contained within the housing 34.

The processor 20 is configured to function as a controller of the manipulator 12. This allows the processor 20 to operate the manipulator 12 to move the limb support 16 precisely in three-dimensional space. The processor 20 operates the manipulator 12 according to conventional robotic control practices to avoid self-collision or collision with objects, and maintain smooth motion of the limb support 16. This involves monitoring and controlling at least one of position, velocity, acceleration, force and/or torque at any of the sections 30, joints 31, free end 14 and fixed end 32.

The system 10 is associated with, or includes, a screen configured to display information relating to the system 10. In the illustrated embodiment, a touch screen 35 is mounted to the apparatus 22. The processor 20 is communicatively connected to the touch screen 35 and configured to operate the screen 35 to display a graphical user interface (GUI). Responsive to the patient 52 or a clinician 50 (FIG. 4) operating the touch screen 35 to activate GUI elements, the processor 20 is configured to receive and act upon user inputs. For example, operating the GUI allows a clinician to define patient identification information and the scale factor for a rehabilitation session.

In some embodiments (not shown), the processor 20 is configured to wirelessly communicate with one or more alternative devices to cause the information, including the GUI, to be displayed on a screen and allow receiving user input, such as communicating with a tablet computer, smartphone, laptop computer and/or smart TV. In such embodiments, the touch screen 35 may be absent from the system 10 to reduce complexity and cost. Further, in such embodiments, the memory store 56 may be hosted in the device.

The processor 20 is further configured to execute one or more video game applications relating to specific rehabilitation exercises, and operate the touch screen 35 to display graphics for the executed video game application. Gameplay is controlled by the input forces exerted relative the limb support 16 by the patient 52, as described in greater detail below.

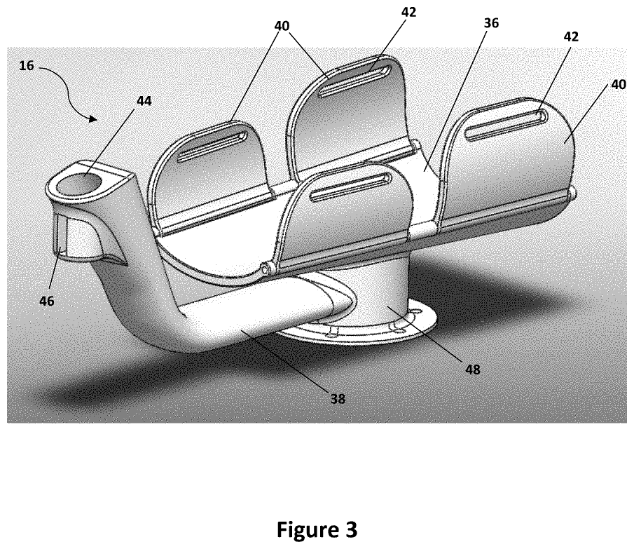

FIG. 3 shows the limb support 16 in isolation. The limb support 16 is shaped to receive a portion of the limb of the patient. In the illustrated embodiment, the limb support 16 defines a support region 36 shaped to partially receive the patient's 52 forearm and a grip 38 spaced at one side of the support region 36 to allow gripping by the patient's 52 hand. It will be appreciated that in other embodiments (not shown) the limb support 16 is configured to support an alternative part of a body, such as a leg or foot.

A plurality of wings 40 are hingedly secured at opposed sides of the support region 36, each wing 40 defining a slot 42. A restraint member (not illustrated), such as a length-adjustable strap or deformable web, is arrangeable between slots 42 of opposed wings 40 to allow the limb support 16 to be releasably secured to the patient's limb. In other embodiments (not shown), the strap, and in some embodiments also the wings 40, are replaced with a resiliently deformable sleeve or cuff shaped to receive the forearm.

The grip 38 is typically configured to receive, or be attached to, one or more user input mechanisms, such as depressible buttons, joysticks, capacitive sensors, force sensor grip, or the like. In the illustrated embodiment, the grip 38 defines a first aperture 44 configured to receive an activation button (not illustrated) and a second aperture 46 configured to receive a trigger button (not illustrated). The processor 20 is communicatively connected with each of the buttons and configured so that operation of the activation button causes operation of the manipulator 12 to initiate or cease, and operation of the trigger button provides input to affect control of video game elements. In other embodiments (not illustrated), the user input mechanisms are absent from the limb support 16 and, instead, are provided in a foot pedal arranged to be operable by the patient to allow the processor 20 to receive user input.

The limb support 16 is typically configured to be securable to the manipulator 12 by a quick-release mechanism. Operation of the quick-release mechanism disengages the limb support 16 from the manipulator 12. In the illustrated embodiment, the quick-release mechanism comprises a magnet (not shown) housed in a base 48 of the limb support 16 and arranged to attract a magnetised plate (not shown) housed in the free end 14 of the manipulator 12. The magnet and plate are configured so that exerting a force on the limb support 16 in one or more defined directions, such as a shear force parallel to the plate, and exceeding a defined safe threshold causes the limb support 16 to separate from the manipulator 12. It will be appreciated that the quick-release mechanism may be alternatively configured to allow separation of the limb support 16 from the manipulator 12 responsive to one or more defined forces being exerted on the limb support 16.

FIG. 4 illustrates the architecture of the system 10. The system 10 is configured to be operable by the clinician 50 and the patient 52. The system 10 allows interaction with the clinician 50 through the GUI and by delivering a patient performance report. The system 10 allows interaction with the patient 52 through supporting limb movement in response to patient input forces, executing the video game application, and delivering the patient performance report.

The processor 20 is configured to operate the touch screen 35, or another device, in a GUI mode 351 to receive clinician input. This allows the clinician 50 to configure the system 10 for a rehabilitation session for a specific patient 52. Clinician input includes defining patient identification information, selecting one or more exercises, selecting one or more video games, and defining the scale factor.

Defining the scale factor typically involves the clinician 50 assessing the level of support which is appropriate for the patient's 52 condition and operating the GUI to define this as percentage. For example, this usually involves defining the value to be between 0-100%. For some applications, the value is defined as greater than 100 to allow applying an assistive force with the manipulator 12 which is greater than double the force applied by the patient (the input force), or the value is defined as less than 0 to allow applying a resistive force with the manipulator 12 to inhibit movement of the patient.

In some embodiments, the memory store 56 defines a calibration process comprising a pattern of defined movements and/or forces. In these embodiments, the processor 20 is configured to operate the touch screen 35 to display graphics to guide the patient 52 through the calibration process. Responsive to receiving input forces, from the sensor 18, and/or identifying movement of the limb support 16 between specific positions corresponding with the defined pattern of movements and/or forces, the processor 20 determines the scale factor appropriate for the patient 52.

Responsive to receiving clinician input, the processor 20 is configured to communicate with the memory store 56, or other memory, to populate a database with clinician input data. When a rehabilitation session is terminated, the processor 20 is further configured to execute a report generator 58, typically being an application, to cause the data, in addition to performance data generated during the session responsive to patient input, to be formatted as the patient performance report. The report is typically communicated in digital format to the clinician 50, such as by email and/or uploading to a clinical data system. The report is configurable to display current session data and, if available, previous session(s) data to allow the clinician 50 to assess a current condition of the patient and any improvement in condition.

The force sensor 18 is arranged to measure linear and/or rotational force (input force) exerted, by the patient 52, relative to the limb support 16. This may involve the patient 52 pressing its limb against the support region 36 or wings 40, and/or pulling away from the support region 36 against the straps. The force sensor 18 is operable to measure input force at a defined sampling frequency, typically greater than 10 Hz and usually around 100 Hz. The processor 20 is configured so that, responsive to each input force measurement, the applied force is calculated and the manipulator 12 is operated to apply the applied force to the limb support 16. This means that the applied force is applied at a corresponding frequency, consequently allowing virtually continuous motion of the limb support 16. The processor 20 is further configured to log each input force and applied force in the memory store 56, or other memory, to allow processing by the report generator 58 and/or populating a database.

The applied force is typically calculated as:

Applied force=input force*(1+scale factor)

Where the scale factor is defined as 0%, the applied force is equal to the input force, meaning that the manipulator 12 is operated such that movement of the limb support 16 corresponds exactly with patient effort thereby providing no support for patient limb movement. Alternatively, where the scale factor is defined as 100%, the applied force is double the input force meaning that the manipulator 12 is operated such that movement of the limb support 16 is significantly greater than patient effort, thereby providing substantial support for patient limb movement.

The processor 20 is configured to disregard force applied to the limb support 16, and consequently the sensor 18, due to the patient's body mass (as a result of gravitational pull) when determining the input force. This involves processing the following calculation:

Input force=Fₙ−F₁

F₁ is an initial force measurement detected by the sensor 18 including gravitational force exerted by patient's limb, the limb support 16 and the sensor 18. Fₙ is a subsequent force measurement detected by the sensor 18. This subtraction method calculates the difference between an exerted input force, due to the patient 52 moving its limb, and a non-exerted input force, due to the weight of the patient's 52 limb.

The limb support 16 is configured to allow further patient input by operating the activation button housed in the grip 38. Responsive to operating this button, the processor 20 is configured to initiate or cease operation of the manipulator 12. This allows the patient to prevent the manipulator 12 from moving to an uncomfortable or harmful position.

The processor 20 is configured to operate the touch screen 35, or another device, in a gaming mode 352 to display the video game graphics. The processor 20 is also configured to affect gameplay, such as controlling an avatar or other game element, responsive to receiving input force from the sensor 18. Each video game application executable by the processor 20 is configured to guide limb movement corresponding with a defined rehabilitation exercise. Controlling gameplay by inputting force, by the patient 52, thereby encourages effective performance of the defined exercise. Furthermore, additional control of gameplay is effected by operating the trigger button houses in the grip 38. Responsive to receiving patient input from the trigger button, the processor 20 is configured to affect the gameplay.

To improve the patient's 52 condition, the patient 52 is guided by the clinician 50 and/or the video game to perform cyclical rehabilitation exercises. Such exercises typically involve moving a limb from a starting position (proximal position) to a distally located position (distal position), and then returning the limb to the starting position. Completion of one cycle between positions is defined as a single repetition. Typically, the patient 52 is instructed by the clinician 50 to complete many repetitions (e.g. 20-30) of a single exercise to enhance limb movement and recovery. Furthermore, the patient 52 is often instructed to perform repetitions of multiple different exercises.

The processor 20 is configured to identify completion of an exercise repetition and, responsive to identifying this, log the repetition in the memory store 56, or another memory. Repetition data is typically entered into the performance report by the report generator 58 and/or communicated to a database.

To allow identifying patient performance of an exercise repetition, movement thresholds are manually or automatically defined for a specific exercise. The thresholds typically define a spatial range, being an approved tolerance, around the proximal position and the distal position. The thresholds are typically defined according to the Right Hand Rule of the x, y, z coordinate system. It will be appreciated that other coordinate or reference systems are suitable.

For example, where an exercise involves the patient 52 moving its hand from in-front of its body to the side of its body, meaning that the limb support 16 z axis position and x axis position should be substantially constant, the proximal and distal position thresholds would define the same upper and lower z axis and x axis thresholds, but different upper and lower y axis thresholds. It will be appreciated that the upper and lower thresholds of each of the proximal position and the distal position may define different values on each of the x, y, and z axis, thereby effectively defining two spaced cubes.

Causing the limb support 16 to be moved, by the patient 52 exerting input force, causes the processor 20 to determine changes in x, y and z axis positions of the limb support 16 and, consequently, identify if the limb support 16 is moved from the proximal position, i.e. defining an x, y, z position within the relevant upper and lower thresholds, to the distal position, i.e. defining an x, y, z position within the relevant upper and lower thresholds, and returned to the proximal position. Responsive to this cycle being successfully completed, the processor 20 logs an exercise repetition.

The processor 20 is configured to determine the position of the limb support at a defined sampling frequency typically being the same or greater than the sensor 18 sampling frequency. This allows the processor 20 to virtually continuously track the position of the limb support 16. This functionality allows the processor 20 to identify any deviation of the limb support 16 from a defined ideal path between the proximal position and the distal position (and vice versa), consequently allowing the processor 20 to determine a quality score for each repetition. The score is typically communicated to the report generator 58 to allow inclusion in the performance report and/or communicated to a data base.

Use of the system 10 involves the clinician 50 touching the touch screen 35, whilst operated in the GUI mode 351, to define the scale factor, and potentially other factors, or execute the scale factor calibration process. The clinician 50 typically also selects one or more video games, by operating the GUI, corresponding with exercises considered appropriate to treat the patient's condition. The patient 52 releasably secures a limb, such as an arm, to the limb support 16, typically by fastening straps or a sleeve about the limb to retain the limb against the support region 36. Where the calibration process is activated, the patient 52 is guided, by graphics displayed on the touch screen 35, to attempt to make specific movements/input specific forces by exerting force, with its limb, relative to the limb support 16.

The patient 52 is instructed by the clinician 50 and/or video game graphics displayed by the touch screen 35, whilst operated in the gaming mode 352, to complete repetitions of an exercise. The patient 52 operates the activation button and attempts to move the limb secured to the limb support 16 according to the instructions, consequently applying input forces to the limb support 16. Each input force is transmitted to the sensor 18 which measures each linear and/or rotational input force and communicates this to the processor 20. The processor 20 calculates the applied force, as a function of the input force and the scale factor, and controls operation of the manipulator 12 to cause the applied force to be applied to the limb support 16. The limb support 16 is then moved, consequently moving the patient's limb.

The patient 52 continues to exert force on the limb support 16 to cause the limb support 16 to be moved according to the exercise. Each successful cycle between the proximal position and the distal position defined for the exercise causes the processor 20 to count a repetition.

When the exercise(s) are completed, the session is terminated, causing the processor 20 to execute the report generator 58. The report generator 58 automatically generates the patient performance report and delivers this to the clinician according to defined preferences.

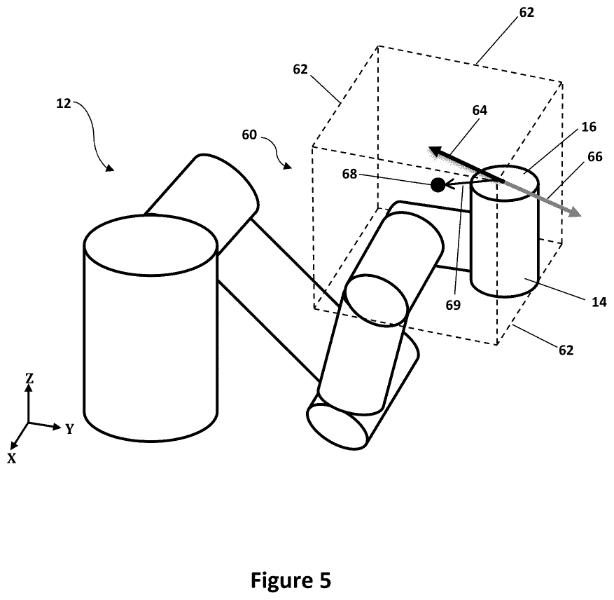

FIG. 5 illustrates a further aspect of the system 10, being a virtual force field 60. The virtual force field 60 is defined in the memory store 56 and defines one or more spatial boundaries 62 extending in at least two dimensions, such as on a plane, or, as shown in FIG. 5, extending in all three dimensions to define a polygon, such as the illustrated box. Additionally or alternatively, the virtual force field 60 is configurable to define at least one rotational position boundary relative to at least one axis. The force field 60 functionality may be integrated into the system 10 configured as illustrated in FIG. 4 and discussed above, or operate independently of the applied force functionality of the system 10.

The virtual force field 60 is defined relative to the manipulator 12, and typically relative to the limb support 16 mounted to the end effector 14. The boundaries 62 determine the range of linear and/or rotational motion of the manipulator 12. When a boundary 62 is reached, the processor 20 is configured to inhibit, and typically prevent, further movement outside of the limitations of the virtual force field 60.

The virtual force field 60 may be defined manually, for example by the clinician 50 assessing an appropriate, safe range of motion for the patient 52, usually by considering a specific injury. Alternatively, the virtual force field 60 is defined automatically responsive to a specific exercise selected for the patient 52, to allow guiding the patient's 52 movement within defined safe limits through the exercise. For example, the boundaries 62 may be associated with a specific video game scenario targeted at treating a specific injury, as described above. Once defined, the boundaries 62 are typically associated with a threshold range (not illustrated) spaced a defined distance inwards from each boundary 62 and towards the manipulator 12.

In the illustrated embodiment, the processor 20 is configured to determine a position and/or orientation of the end effector 14, and consequently the limb support 16, relative to the boundaries 62, and/or rotational position boundaries, of the virtual force field 60. When the processor 20 determines the limb support 16 is within a threshold range of any boundary of the virtual force field 60, the processor 20 determines a resistance force 64 to counteract the input force 66, exerted by the patient 52, acting towards the boundary 62, and operates the manipulator 12 to apply the resistance force 64 to inhibit the limb support 16 from moving outside of the virtual force field 60. The processor 20 is typically configured to rapidly increase the resistance force 64 proportionally to the limb support 16 being urged into the threshold range and towards the boundary 62.

Whilst FIG. 5 illustrates the resistance force 64 as being linear, it will be appreciated that the input force 66 may be torque, or comprise a combination of linear force and torque, and the processor 20 is configurable to determine the resistance force 64 to be, or comprise, rotational force to counteract this, and operate the manipulator 12 to apply resistive torque to prevent the limb support 16 moving outside of the force field 60.

The processor 20 is typically also configured to determine a position of the limb support 16 relative to a centre point 68 of the virtual force field 60. This is expressed as a vector 69. The resistance force 64 is calculated as a product of the input force 66 and the vector 69 to effectively counteract the input force 66 by causing the manipulator 12 to exert the resistance force 69 being equal to, or greater than, the input force 66 and towards the centre point 68. This provides the patient 52 with haptic feedback simulating abutting a surface.

The resistance force 64 is typically calculated by the processor 20 to counteract only the linear and/or rotational component(s) of the input force 66 acting against the boundaries 62. This allows the patient 52 to move the limb support 16 along, but not past, the boundary 62, simulating urging the limb support 16 against a wall or floor. This can usefully allow controlling motion of the limb support 16 along a plane to enhance treatment.

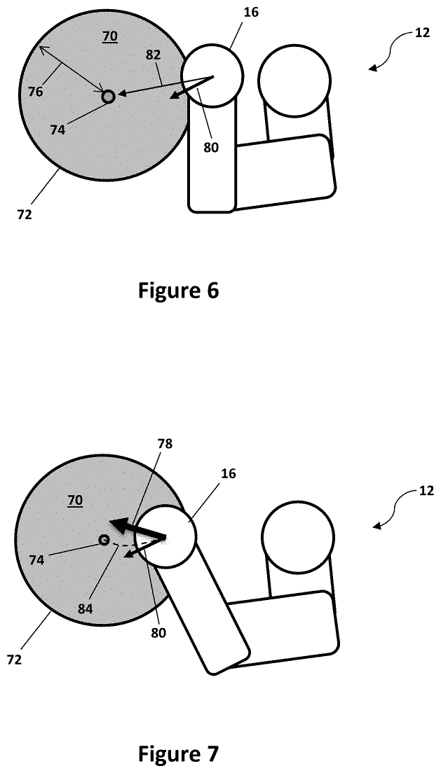

FIGS. 6 and 7 illustrate another aspect of the system 10, being a motion guidance field 70. The motion guidance field 70 is defined in the memory store 56 and defines one or more spatial boundaries 72 extending in at least two dimensions, such as on a plane, or, as shown in FIGS. 6 and 7, extending in all three dimensions to define a polygon, such as the illustrated sphere. The motion guidance field 70 functionality may be integrated into the system 10 configured as illustrated in FIG. 4 and discussed above, or operate independently of the applied force functionality of the system 10, or independently of the force sensor 18.

The boundaries 72 of the motion guidance field 70 are defined relative to a target position 74, typically being defined by a radius 76 extending outwardly from the target position 74. The target position 74 is a point in three-dimensional space which represents an end-point of an exercise. In some embodiments, the target position 74 is associated with a target orientation (not illustrated), defining a plane arranged about three perpendicular axes extending through the target position 74. The boundaries 72 determine the spatial range within which the processor 20 will cause the motion guidance functionality to operate to effect movement of the manipulator 12 and consequently the limb support 16.

The motion guidance field 70 may be defined manually, for example by the clinician 50 assessing an appropriate distance within which the patient 52 will require assistance to move the limb support 16 to the target position 74, usually by considering a specific injury. Alternatively, the motion guidance field 70 is defined automatically responsive to a specific exercise selected for the patient 52 to assist the patient 52 to complete the exercise.

The processor 20 is configured to determine a position of the end effector 14, and consequently the limb support 16, relative to the target position 74 and, if defined target orientation. When the processor 20 determines the limb support 16 is within the motion guidance field 70 for a defined period, for example, 5 seconds, the processor 20 determines an assist force 78 and operates the manipulator 12 to apply the assist force 78 to move the limb support 16 to the target position. The processor 20 is typically configured to increase the assist force 78 as the limb support 16 moves closer to the target position, i.e. proportionally to decreasing a distance between the limb support 16 and the target position 74, to simulate a ‘magnetic effect’ to draw and accelerate the limb support 16 towards the target position 74.

Whilst FIG. 7 illustrates the assist force 78 as being linear, it will be appreciated that the assist force 78 may be determined by the processor 20 as torque, or comprise a combination of linear force and torque, to allow guiding the patient's limb in an appropriate, safe posture when moving the limb support 16 towards the target position 74. Furthermore, the processor 20 may determine torque to be applied by the manipulator 12 to achieve the target orientation associated with the target position 74.

In the illustrated embodiment, the processor 20 is configured to determine the assist force 78 as a product of the input force 80, exerted by the patient 52, and a vector 82 between the end effector 14 and the target position 74. The assist force 78 consequently re-directs movement of the limb support 16 until it reaches the target position 74, as illustrated by the curved path 84 shown in FIG. 7. This is useful where the patient 52 is able to move the limb support 16 near to the target position 74, but lacks the strength and/or agility to reach the target position 74 and may, for example, cease moving the limb support 16. Executing the motion guidance field 70 functionality resolves this by providing additional physical support to cause the patient 52 to complete the exercise, consequently enhancing therapy and reducing physical burden on the clinician 50.

The disclosed system 10 allows the patient's 52 limb to be supported, by the manipulator 12 and the limb support 16, through a wide range of motion. Movement of the limb, by the manipulator 12 and support 16, is guided solely by the patient's 52 input forces. This effectively allows free movement of the limb, with a defined level of mechanical assistance (defined by the scale factor), which allows and enhances performance of virtually any exercise by the patient 52. This can consequently enhance and/or expedite recovery of the patient 52.

By providing mechanical assistance to patient 52 limb movement throughout each exercise, the system 10 advantageously reduces physical loads on the clinician 50 which reduces likelihood of injury. Also, as the exercises can be guided by the video game, the patient 52 can perform the exercises unsupervised by the clinician 50, meaning that the clinician 50 can treat multiple patients 52 simultaneously.

The system 10 is configured to monitor patient input forces and resulting movements and automatically generate patient performance reports and/or upload patient data to a data base. This reduces administrative burden on clinicians 50, enhances assessing the patient's 52 condition by the clinician, and, when a substantial volume of patient performance data is generated, allows analysts to assess the data to determine efficacy of exercises on recovery rates. This analysis therefore allows rehabilitation exercises to be modified to improve efficacy.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for mechanically assisting rehabilitation of a patient, the system including:
a manipulator having at least five degrees of freedom and defining a free end;
a limb support for supporting a limb of the patient, the limb support secured relative to the free end of the manipulator;
a force sensor operatively connected to the limb support to allow measuring input forces applied to the limb support by the patient moving its limb; and
a processor communicatively connected to the force sensor, the manipulator, and a memory store defining a scale factor, the processor configured to control operation of the manipulator to move the limb support,
wherein the processor is configured so that responsive to receiving an input force measurement from the force sensor, the processor determines an applied force as a function of the input force and the scale factor, and operates the manipulator to apply the applied force to the limb support to cause the limb support to move.

2. The system of claim 1, wherein the scale factor is defined as a percentage of the input force.

3. The system of claim 1 or 2, wherein the memory store defines a calibration process including a sequence of defined forces, and, responsive to receiving force measurements corresponding with the sequence, the processor is configured to define the scale force.

4. The system of any one of the preceding claims, wherein the force sensor is configured to measure input force at a defined frequency of greater than 10 Hz, and the processor is configured to determine and apply the applied force responsive to receiving each input force measurement to apply the applied force at a corresponding frequency.

5. The system of claim 4, wherein the defined frequency is equal to, or greater than, 100 Hz.

6. The system of any one of the preceding claims, wherein the processor is configured to determine a position of the limb support relative to a reference position, and wherein the memory store defines a pair of movement thresholds relating to an exercise, and wherein the processor is further configured so that responsive to determining that the limb support is moved in a cycle between the thresholds, the processor logs an exercise repetition in the memory store.

7. The system of claim 6, wherein the processor is configured to populate a database with the scale factor, input force measurements and exercise repetitions logged in a rehabilitation session.

8. The system of claim 6 or 7, wherein the processor is configured to populate a report with patient identification information, the scale factor and exercise repetitions logged in a rehabilitation session.

9. The system of any one of the preceding claims, wherein the processor is configured to determine a position of the limb support relative to a target position, and wherein responsive to the processor determining the limb support is within a defined range of the target position for a defined period, the processor determines an assist force and operates the manipulator to apply the assist force, in addition to the applied force, to cause the limb support to move to the target position.

10. The system of claim 9, wherein the processor is configured to increase the assist force proportionally to decreasing a distance between the limb support and the target position.

11. The system of claim 9 or 10 wherein the assist force comprises at least one of linear force and torque.

12. The system of any one of the preceding claims, wherein the memory store defines a virtual force field defining one or more boundaries in at least two dimensions, and the processor is configured to determine a position of the limb support relative to the one or more boundaries, wherein responsive to the processor determining the limb support is within a threshold range of any boundary of the virtual force field, the processor determines a resistance force to counteract the input force acting towards the boundary, and operates the manipulator to apply the resistance force to inhibit the limb support from moving outside of the virtual force field.

13. The system of claim 12 wherein the resistance force comprises at least one of linear force and torque.

14. The system of any one of the preceding claims, wherein the processor is communicatively connected to a screen and configured to operate the screen to display graphics relating to exercises.

15. The system of claim 14, wherein the processor is configured to execute a video game application relating to the exercises, and wherein the graphics illustrate elements of the video game.

16. The system of claim 15, wherein the processor is configured so that responsive to receiving an input force measurement from the sensor, the processor effects control of one or more of the elements of the video game, and operates the screen to display the control of the one or more elements.

17. The system of any of claims 14 to 16 including a touch screen operable to display the graphics and receive user input.

18. The system of any one of the preceding claims including a base connected to the manipulator and configured to support the manipulator relative to a surface.

19. The system of claim 18, wherein the base includes an elevation mechanism operable to lift the manipulator away from the surface.

20. The system of any one of the preceding claims, wherein the limb support includes a patient input mechanism communicatively connected to the processor, and wherein the processor is configured so that responsive to operation of the patient input mechanism, the processor causes one of initiating and ceasing movement of the manipulator.

21. The system of any one of the preceding claims including a quick-release mechanism arranged to releasably connect the limb support to the free end of the manipulator, and wherein operating the quick-release mechanism allows the limb support to be disengaged from the manipulator.

22. The system of any one of the preceding claims, wherein the limb support is shaped to receive a portion of the limb of the patient.

23. The system of any one of the preceding claims, wherein the limb support includes at least one restraint member configured to allow releasably securing the limb support to the limb of the patient.

24. The system of any one of the preceding claims, wherein the force sensor is a force-torque sensor arranged to measure linear force and torque applied to the limb support by the patient.

25. A method for mechanically assisting rehabilitation of a patient, the method including:
defining a scale factor;
releasably securing a limb of the patient against a limb support secured relative to an end effector of a manipulator;
exerting force, by the limb of the patient, causing the limb support to transmit an input force to a force sensor operatively connected to the limb support;
receiving the input force, by a processor, and determining an applied force as function of the scale factor and the input force; and
operating the manipulator, by the processor, to apply the applied force to the limb support, causing the limb support to move the patient's limb.

26. A system for mechanically assisting rehabilitation of a patient, the system including:
a manipulator having at least five degrees of freedom and defining a free end;
a limb support for supporting a limb of the patient, the limb support secured relative to the free end of the manipulator;
a force sensor operatively connected to the limb support to allow measuring input forces applied to the limb support by the patient; and
a processor communicatively connected to the force sensor, the manipulator, and a memory store storing a virtual force field defining one or more boundaries in at least two dimensions, the processor configured to control operation of the manipulator to move the limb support, and configured to determine a position of the limb support relative to the boundaries,
wherein responsive to the processor determining the limb support is within a threshold range of any boundary of the virtual force field, the processor determines a resistance force to counteract the input force acting towards the boundary, and operates the manipulator to apply the resistance force to inhibit the limb support from moving outside of the virtual force field.

27. A system for mechanically assisting rehabilitation of a patient, the system including:
a manipulator having at least five degrees of freedom and defining a free end;
a limb support for supporting a limb of the patient, the limb support secured relative to the free end of the manipulator;
a processor communicatively connected to the manipulator and a memory store defining a target position, the processor configured to control operation of the manipulator to move the limb support, and configured to determine a position of the limb support relative to the target position,
wherein responsive to the processor determining the limb support is within a defined range of the target position for a defined period, the processor determines an assist force and operates the manipulator to apply the assist force to cause the limb support to move to the target position.

28. The system of claim 27, wherein the processor is configured to increase the assist force proportionally to decreasing a distance between the limb support and the target position.
